(19) United States
(12) Patent Application Publication
(10) Pub. No.: US 2014/0157209 A1
(43) Pub. Date: Jun. 5, 2014

(54) SYSTEM AND METHOD FOR DETECTING GESTURES

(71) Applicant: Google Inc., Mountain View, CA (US)

(72) Inventors: Navneet Dalal, San Francisco, CA (US); Mehul Nariyawala, Fremont, CA (US); Ankit Mohan, San Francisco, CA (US); Varun Gulshan, San Francisco, CA (US)

(73) Assignee: Google Inc., Mountain View, CA (US)

(21) Appl. No.: 13/796,772

(22) Filed: Mar. 12, 2013

Related U.S. Application Data
(60) Provisional application No. 61/732,840, filed on Dec. 3, 2012.

(51) Int. Cl. G06F 3/01

(52) U.S. Cl. CPC G06F 3/017
USPC 715/863

(57) ABSTRACT

A system and method that includes detecting an application change within a multi-application operating framework; updating an application hierarchy model for gesture-to-action responses with the detected application change; detecting a gesture; according to the hierarchy model, mapping the detected gesture to an action of an application; and triggering the action.

### CROSS-REFERENCE TO RELATED APPLICATIONS

This application claims the benefit of U.S. Provisional Application Ser. No. 61/732,840, filed on 3 Dec. 2012, which is incorporated in its entirety by this reference.

### TECHNICAL FIELD

This invention relates generally to the user interface field, and more specifically to a new and useful method and system for detecting gestures in the user interface field.

### BACKGROUND

There have been numerous advances in recent years in the area of user interfaces. Touch sensors, motion sensing, motion capture, and other technologies have enabled gesture based user interfaces. Such new techniques, however, often require new and often expensive devices or hardware components to enable a gesture based user interface. For these techniques to enable even simple gestures require considerable processing capabilities and advancement in algorithms. More sophisticated and complex gestures require even more processing capabilities of a device, thus limiting the applications of gesture interfaces. Furthermore, the amount of processing can limit the other tasks that can occur at the same time. Additionally, these capabilities are not available on many devices such as mobile devices were such dedicated processing is not feasible. Additionally, the current approaches often leads to a frustrating lag between a gesture of a user and the resulting action in an interface. Another limitation of such technologies is that they are designed for limited forms of input such as gross body movement guided by application feedback. Thus, there is a need in the user interface field to create a new and useful method and system for detecting gestures. This invention provides such a new and useful method and system.

### BRIEF DESCRIPTION OF THE FIGURES

FIG. 1 is a schematic representation of a method of a preferred embodiment;

FIG. 2 is detailed flowchart representation of a obtaining images of a preferred embodiment;

FIG. 3 is a flowchart representation of detecting a motion region of a preferred embodiment;

FIGS. 4A and 4B are schematic representations of example gestures using a combination of hand/s and facial features of a user in accordance with the preferred embodiment;

FIG. 5 is a flowchart representation of computing feature vectors of a preferred embodiment;

FIG. 6 is a flowchart representation of determining a gesture input;

FIG. 7 is a schematic representation of tracking motion of an object;

FIG. 8 is a schematic representation of transitioning gesture detection process between processing units;

FIG. 9 is a schematic representation of a system of a preferred embodiment;

FIG. 10 is a schematic representation of a system of a preferred embodiment;

FIG. 11 is a flowchart representation of a method of a preferred embodiment;

FIGS. 12-14 are schematic representations of exemplary scenarios of a method of a preferred embodiment;

FIGS. 15A-15J are schematic representations of a series of example gestures using one or more hands of a user in accordance with the preferred embodiment; and

FIG. 16 is a schematic representation of an exemplary advertisement based gesture of a preferred embodiment.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### 1. Methods for Detecting Gestures

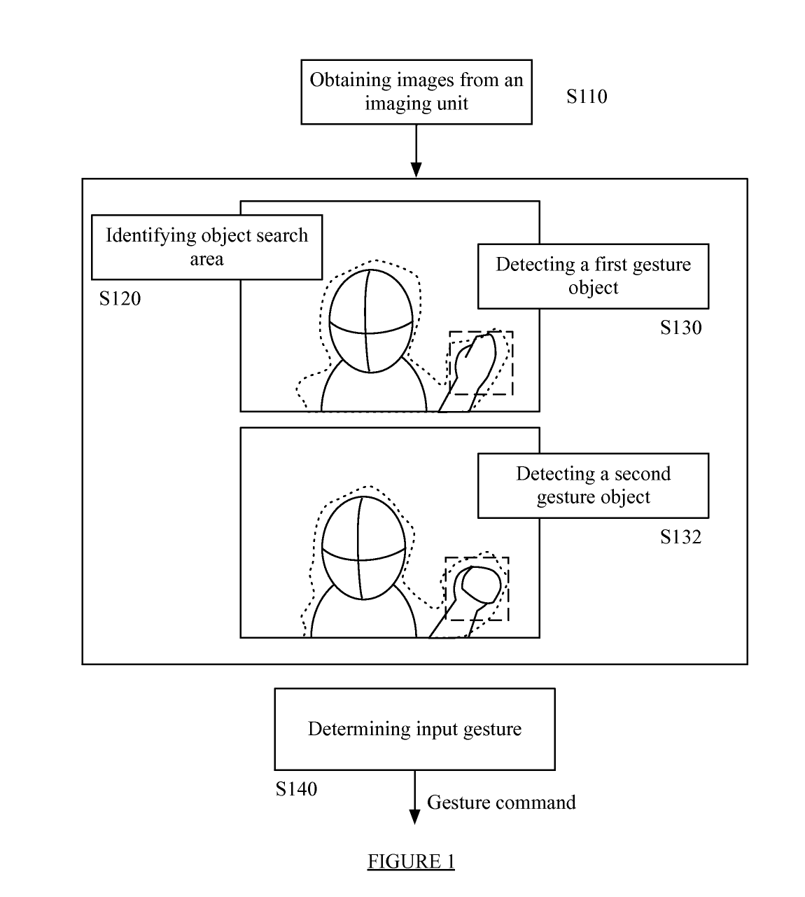

As shown in FIG. 1, a method for detecting gestures of a preferred embodiment includes the steps of obtaining images from an imaging unit S110; identifying object search area of the images S120; detecting a first gesture object in the search area of an image of a first instance S130; detecting a second gesture object in the search area of an image of at least a second instance S132; and determining an input gesture from the detection of the first gesture object and the at least second gesture object S140. The method functions to enable an efficient gesture detection technique using simplified technology options. The method primarily utilizes object detection as opposed to object tracking (though object tracking may additionally be used). A gesture is preferably characterized by a real world object transitioning between at least two configurations. The detection of a gesture object in one configuration in at least one image frame may additionally be used as a gesture. The method can preferably identify images of the object (i.e., gesture objects) while in various stages of configurations. For example, the method can preferably be used to detect a user flicking their fingers from side to side to move forward or backwards in an interface. Additionally, the steps of the method are preferably repeated to identify a plurality of types of gestures. These gestures may be sustained gestures (e.g., such as a thumbs-up), change in orientation of a physical object (e.g., flicking fingers and/or a hand side to side), combined object gestures (e.g., using face and hand to signal a gesture), gradual transition of gesture object orientation, changing position of detected objet, and any suitable pattern of detected/tracked objects. The method may be used to identify a wide variety of gestures and types of gestures through one operation process.

The method is preferably implemented through an imaging unit capturing video such as a RGB digital camera like a web camera or a camera phone, but may alternatively be implemented by any suitable imaging unit such as stereo camera, 3D scanner, or IR camera. In one variation, the imaging unit can be directly connected to and/or integrated with a display, user interface, or other user components. Alternatively, the imaging unit can be a discrete element within a larger system that is not connected to any particular device, display, user interface, or the like. Preferably, the imaging unit is connectable to a controllable device, which can include for example a display and/or audio channel. Alternatively, the controllable device can be any suitable electronic device or appliance subject to control though electrical signaling. The method preferably leverages image based object detection algorithms, which preferably enables the method to be used for gestures involving arbitrarily complex gestures. For example, the method can preferably detect gestures involving finger movement and hand position without sacrificing operation efficiency or increasing system requirements. One exemplary application of the method preferably includes being used as a user interface to a computing unit such as a personal computer, a mobile phone, an entertainment system, or a home automation unit. The method may be used for computer input, attention monitoring, mood monitoring, in an advertisement unit and/or any suitable application. The system implementing the method can preferably be activated by clicking a button, using an ambient light sensor to detect a user presence, detecting a predefined action (e.g., placing hand over the light sensor and taking it off within a few seconds), or any suitable technique for activating and deactivating the method.

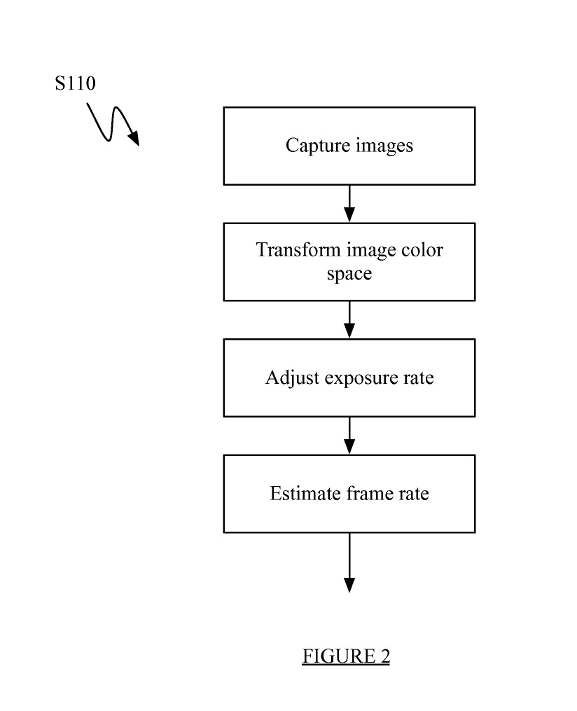

Step S110, which includes obtaining images from an imaging unit S110, functions to collect data representing physical presence and actions of a user. The images are the source from which gesture input will be generated. The imaging unit preferably captures image frames and stores them. Depending upon ambient light and other lighting effects such as exposure or reflection, it optionally performs pre-processing of images for later processing stages (shown in FIG. 2). The camera is preferably capable of capturing light in the visible spectrum like a RGB camera, which may be found in web cameras, web cameras over the internet or local Wi-Fi/home/office networks, digital cameras, smart phones, tablet computers, and other computing devices capable of capturing video. Any suitable imaging system may alternatively be used. A single unique camera is preferably used, but a combination of two or more cameras may alternatively be used. The captured images may be multi-channel images or any suitable type of image. For example, one camera may capture images in the visible spectrum, while a second camera captures near infrared spectrum images. Captured images may have more than one channel of image data such as RGB color data, near infra-red channel data, a depth map, or any suitable image representing the physical presence of a objects used to make gestures. Depending upon historical data spread over current and prior sessions, different channels of a source image may be used at different times. Additionally, the method may control a light source for when capturing images. Illuminating a light source may include illuminating a multi spectrum light such as near infrared light or visible light source. One or more than one channel of the captured image may be dedicated to the spectrum of a light source. The captured data may be stored or alternatively used in real-time processing. Pre-processing may include transforming image color space to alternative representations such as Lab, Luv color space. Any other mappings that reduce the impact of exposure might also be performed. This mapping may also be performed on demand and cached for subsequent use depending upon the input needed by subsequent stages. Additionally or alternatively, preprocessing may include adjusting the exposure rate and/or frame rate depending upon exposure in the captured images or from reading sensors of an imaging unit. The exposure rate may also be computed by taking into account other sensors such as strength of GPS signal (e.g., providing insight into if the device is indoor or outdoor), time of the day or year. The system may also use the location of a device via WiFi points, GPS signal, or any other way to determinate the approximate location in order to tune the image capture process. This would typically impact frame rate of the images. The exposure may alternatively be adjusted based on historical data. In addition to capturing images, an instantaneous frame rate is preferably calculated and stored. This frame rate data may be used to calculate and/or map gestures to a reference time scale.

Step S120, which includes identifying object search area of the images, functions to determine at least one portion of an image to process for gesture detection. Identifying an object search area preferably includes detecting and excluding background areas of an image and/or detecting and selecting motion regions of an image. Additionally or alternatively, past gesture detection and/or object detection may be used to determine where processing should occur. Identifying object search area preferably reduces the areas where object detection must occur thus decreasing runtime computation and increasing accuracy. The search area may alternatively be the entire image. A search area is preferably identified for each image of obtained images, but may alternatively be used for a group plurality of images.

When identifying an object search area, a background estimator module preferably creates a model of background regions of an image. The non-background regions are then preferably used as object search areas. Statistics of image color at each pixel are preferably built from current and prior images frames. Computation of statistics may use mean color, color variance, or other methods such as median, weighted mean or variance, or any suitable parameter. The number of frames used for computing the statistics is preferably dependent on the frame rate or exposure. The computed statistics are preferably used to compose a background model. In another variation, a weighted mean with pixels weighted by how much they differ from an existing background model may be used. These statistical models of background area are preferably adaptive (i.e., the background model changes as the background changes). A background model will preferably not use image regions where motion occurred to update its current background model. Similarly, if a new object appears and then does not move for a number of subsequent frames, the object will preferably in time be regarded as part of the background. Additionally or alternatively, creating a model of background regions may include applying an operator over a neighborhood image region of a substantial portion of every pixel, which functions to create a more robust background model. The span of a neighborhood region may change depending upon current frame rate or lighting. A neighborhood region can increase when frame rate is low in order to build more a robust and less noisy background model. One exemplary neighborhood operator may include a Gaussian kernel. Another exemplary neighborhood operator is a super-pixel based neighborhood operator that computes (within a fixed neighborhood region) which pixels are most similar to each other and group them in one super-pixel. Statistics collection is then preferably performed over only those pixels that classify in the same super-pixel as the current pixel. One example of super-pixel based method is to alter behavior if the gradient magnitude for a pixel is above a specified threshold.

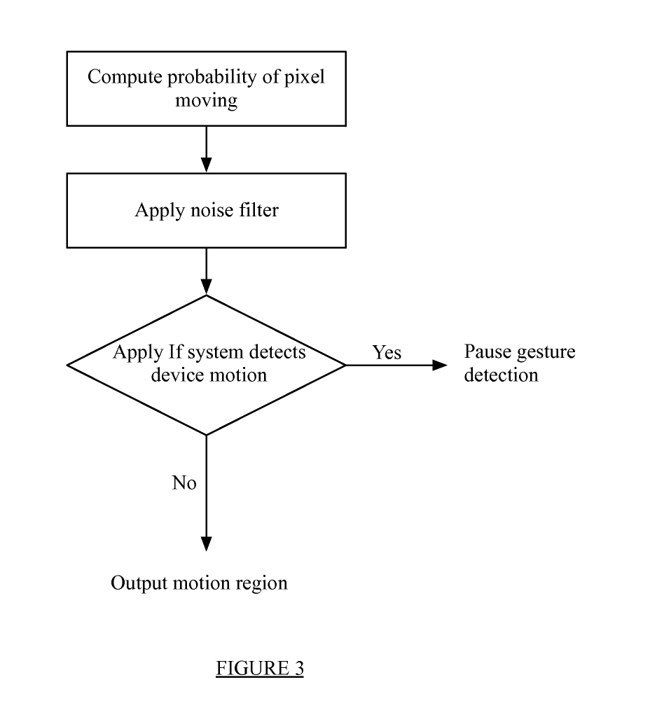

Additionally or alternatively, identifying an object search area may include detecting a motion region of the images. Motion regions are preferably characterized by where motion occurred in the captured scene between two image frames. The motion region is preferably a suitable area of the image to find gesture objects. A motion region detector module preferably utilizes the background model and a current image frame to determine which image pixels contain motion regions. As shown in FIG. 3, detecting a motion region of the images preferably includes performing a pixel-wise difference operation and computing probability a pixel has moved. The pixel-wise difference operation is preferably computed using the background model and a current image. Motion probability may be calculated in a number of ways. In one variation, a Gaussian kernel (exp(−SSD(x_{current}, x_{background})/s)) is preferably applied to a sum of square difference of image pixels. Historical data may additionally be down weighted as motion moves further away in time from the current frame. In another variation, a sum of square difference (SSD function) may be computed over any one channel or any suitable combination of channels in the image. A sum of absolute difference per channel function may alternatively be used in place of the SSD function. Parameters of the operation may be fixed or alternatively adaptive based on current exposure, motion history, and ambient light and user preferences. In another variation, a conditional random field based function may be applied where the computation of each pixel to be background uses pixel difference information from neighborhood pixels, image gradient, and motion history for a pixel, and/or the similarity of a pixel compared to neighboring pixels.

The probability image may additionally be filtered for noise. In one variation, noise filtering may include running a motion image through a morphological erosion filter and then applying a dilation or Gaussian smoothing function followed by applying a threshold function. Different algorithms may alternatively be used. Motion region detection is preferably used in detection of an object, but may additionally be used in the determination of a gesture. If the motion region is above a certain threshold the method may pause gesture detection. For example, when moving an imaging unit like a smartphone or laptop, the whole image will typically appear to be in motion. Similarly motion sensors of the device may trigger a pausing of the gesture detection.

Steps S130 and S132, which include detecting a first gesture object in the search area of an image of a first instance and detecting a second gesture object in the search area of an image of at least a second instance, function to use image object detection to identify objects in at least one configuration. The first instance and the second instance preferably establish a time dimension to the objects that can then be used to interpret the images as a gesture input in Step S140. The system may look for a number of continuous gesture objects. A typical gesture may take approximately 300 milliseconds to perform and span approximately 3-10 frames depending on image frame rate. Any suitable length of gestures may alternatively be used. This time difference is preferably determined by the instantaneous frame rate, which may be estimated as described above. Object detection may additionally use prior knowledge to look for an object in the neighborhood of where the object was detected in prior images.

A gesture object is preferably a portion of a body such as a hand, pair of hands, a face, portion of a face, or combination of one or more hands, a face, user object (e.g., a phone) and/or any other suitable identifiable feature of the user. Alternatively, the gesture objet can be a device, instrument or any suitable object. Similarly, the user is preferably a human but may alternatively be any animal or device capable of creating visual gestures. Preferably a gesture involves an object(s) in a set of configuration. The gesture object is preferably any object and/or configuration of an object that may be part of a gesture. A general presence of an object (e.g., a hand), a unique configuration of an object (e.g., a particular hand position viewed from a particular angle) or a plurality of configurations may distinguish a gesture object (e.g., various hand positions viewed generally from the front). Additionally, a plurality of objects may be detected (e.g., hands and face) for any suitable instance.

In another embodiment, hands and the face are detected for cooperative gesture input. As described above, a gesture is preferably characterized by an object transitioning between two configurations. This may be holding a hand in a first configuration (e.g., a fist) and then moving to a second configuration (e.g., fingers spread out). Each configuration that is part of a gesture is preferably detectable. A detection module preferably uses a machine-learning algorithm over computed features of an image. The detection module may additionally use online leaning which functions to adapt gesture detection to a specific user. Identifying the identity of a user through face recognition may provide additional adaption of gesture detection. Any suitable machine learning or detection algorithms may alternatively be used. For example, the system may start with an initial model for face detection, but as data is collected for detection from a particular user the model may be altered for better detection of the particular face of the user. The first gesture object and the second gesture object are typically the same physical object in different configurations. There may be any suitable number of detected gesture objects. For example, a first gesture object may be a hand in a fist and a second gesture object may be an opened hand. Alternatively, the first gesture object and the second gesture object may be different physical objects. For example, a first gesture object may be the right hand in one configuration, and the second gesture object may be the left hand in a second configuration. Similarly gesture object may be the combination of multiple physical objects such as multiple hands, objects, faces and may be from one or more users. For example, such gesture objects may include holding hands together, putting hand to mouth, holding both hands to side of face, holding an object in particular configuration or any suitable detectable configuration of objects. As will be described in Step S140, there may be numerous variations in interpretation of gestures.

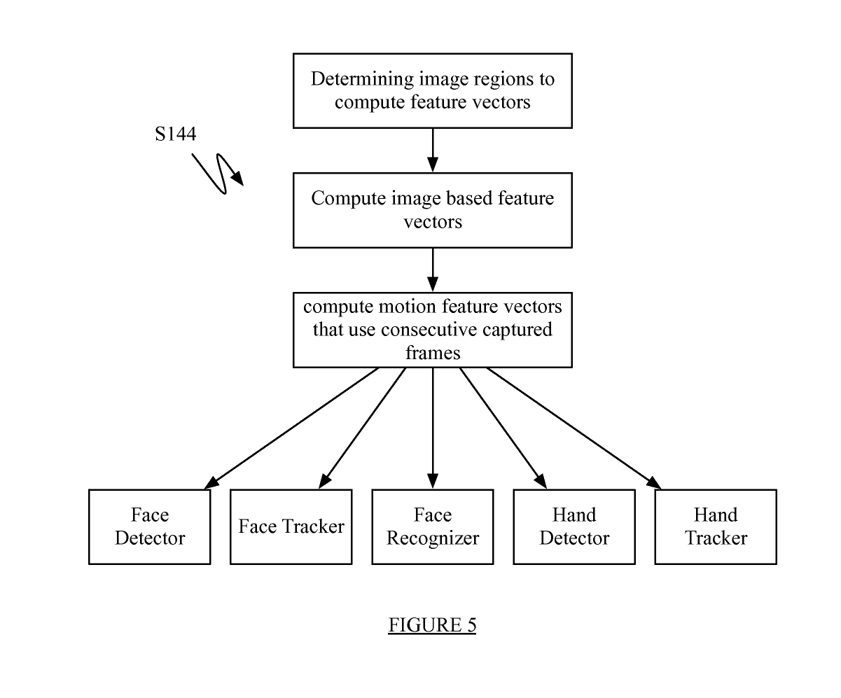

Additionally, an initial step for detecting a first gesture object and/or detecting a second gesture object may be computing feature vectors S144, which functions as a general processing step for enabling gesture object detection. The feature vectors can preferably be used for face detection, face tracking, face recognition, hand detector, hand tracking, and other detection processes, as shown in FIG. 5. Other steps may alternatively be performed to detect a gesture objects. Pre-computing a feature vector in one place can preferably enable a faster overall computation time. The feature vectors are preferably computed before performing any detection algorithms and after any pre-processing of an image. Preferably, an object search area is divided into potentially overlapping blocks of features where each block further contains cells. Each cell preferably aggregates pre-processed features over the span of the cell through use of a histogram, by summing, by Haar wavelets based on summing/differencing or based on applying alternative weighting to pixels corresponding to cell span in the preprocessed features, and/or by any suitable method. Computed feature vectors of the block are then preferably normalized individually or alternatively normalized together over the whole object search area. Normalized feature vectors are preferably used as input to a machine-learning algorithm for object detection, which is in turn used for gesture detection. The feature vectors are preferably a base calculation that converts a representation of physical objects in an image to a mathematical/numerical representation. The feature vectors are preferably usable by plurality of types of object detection (e.g., hand detection, face detection, etc.), and the feature vectors are preferably used as input to specialized object detection. Feature vectors may alternatively be calculated independently for differing types of object detection. The feature vectors are preferably cached in order to avoid re-computing feature vectors. Depending upon a particular feature, various caching strategies may be utilized, some can share feature computation. Computing feature vectors is preferably performed for a portion of the image, such as where motion occurred, but may alternatively be performed for a whole image. Preferably, stored image data and motion regions is analyzed to determine where to compute feature vectors.

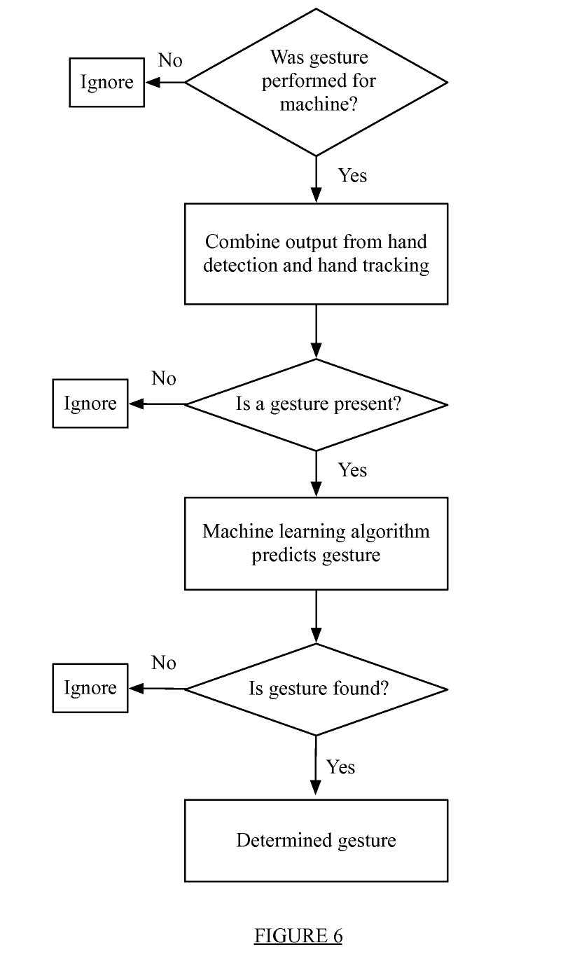

Step S140, which includes determining an input gesture from the detection of the first gesture object and the at least second gesture object, functions to process the detected objects and map them according to various patterns to an input gesture. A gesture is preferably made by a user by making changes in body position, but may alternatively be made with an instrument or any suitable gesture. Some exemplary gestures may include opening or closing of a hand, rotating a hand, waving, holding up a number of fingers, moving a hand through the air, nodding a head, shaking a head, or any suitable gesture. An input gesture is preferably identified through the objects detected in various instances. The detection of at least two gesture objects may be interpreted into an associated input based on a gradual change of one physical object (e.g., change in orientation or position), sequence of detection of at least two different objects, sustained detection of one physical object in one or more orientations, or any suitable pattern of detected objects. These variations preferably function by processing the transition of detected objects in time. Such a transition may involve the changes or the sustained presence of a detected object. One preferred benefit of the method is the capability to enable such a variety of gesture patterns through a single detection process. A transition or transitions between detected objects may be one variation indicate what gesture was made. A transition may be characterized by any suitable sequence and/or positions of a detected object. For example, a gesture input may be characterized by a fist in a first instance and then an open hand in a second instance. The detected objects may additionally have location requirements, which may function to apply motion constraints on the gesture. As shown in FIG. 6, there may be various conditions of the object detection that can end gesture detection prematurely. Two detected objects may be required to be detected in substantially the same area of an image, have some relative location difference, have some absolute or relative location change, satisfy a specified rate of location change, or satisfy any suitable location based conditions. In the example above, the first and the open hand may be required to be detected in substantially the same location. As another example, a gesture input may be characterized by a sequence of detected objects gradually transitioning from a fist to an open hand. (e.g., a fist, a half open hand, and then an open hand). The system may directly predict gestures once features are computed over images. So explicit hand detection/tracking may never happen and a machine-learning algorithm may be applied to predict gestures post identification of a search area. The method may additionally include tracking motion of an object. In this variation, a gesture input may be characterized by detecting an object in one position and then detecting the object or a different object in a second position. In another variation, the method may detect an object through sustained presence of a physical object in substantially one orientation. In this variation, the user presents a single object to the imaging unit. This object in a substantially singular orientation is detected in at least two frames. The number of frames and threshold for orientation changes may be any suitable number. For example, a thumbs-up gesture may be used as an input gesture. If the method detects a user making a thumbs-up gesture for at least two frames then an associated input action may be made. The step of detecting a gesture preferably includes checking for the presence of an initial gesture object(s). This initial gesture object is preferably an initial object of a sequence of object orientations for a gesture. If an initial gesture object is not found, further input is preferably ignored. If an object associated with at least one gesture is found the method proceeds to detect a subsequent object of gesture. These gestures are preferably detected by passing feature vectors of an object detector combined with any object tracking to a machine learning algorithm that predicts the gesture. A state machine, conditional logic, machine learning, or any suitable technique may be used to determine a gesture. The system may additionally use the device location (e.g., through WiFi points or GPS signal), lighting conditions, user facial recognition, and/or any suitable context of the images to modify gesture determination. For example, different gestures may be detected based on the context. When the gesture is determined an input is preferably transferred to a system, which preferably issues a relevant command. The command is preferably issued through an application programming interface (API) of a program or by calling OS level APIs. The OS level APIs may include generating key and/or mouse strokes if for example there are no public APIs for control. For use within a web browser, a plugin or extension may be used that talks to the browser or tab. Other variations may include remotely executing a command over a network.

In some embodiments, the hands and a face of a user are preferably detected through gesture object detection and then the face object preferably augments interpretation of a hand gesture. In one variation, the intention of a user is preferably interpreted through the face, and is used as conditional test for processing hand gestures. If the user is looking at the imaging unit (or at any suitable point) the hand gestures of the user are preferably interpreted as gesture input. If the user is looking away from the imaging unit (or at any suitable point) the hand gestures of the user are interpreted to not be gesture input. In other words, a detected object can be used as an enabling trigger for other gestures. As another variation of face gesture augmentation, the mood of a user is preferably interpreted. In this variation, the facial expressions of a user serve as a configuration of the face object. Depending on the configuration of the face object, a sequence of detected objects may receive different interpretations. For examples, gestures made by the hands may be interpreted differently depending on if the user is smiling or frowning. In another variation, user identity is preferably determined through face recognition of a face object. Any suitable technique for facial recognition may be used. Once user identify is determined, the detection of a gesture may include applying personalized determination of the input. This may involve loading personalized data set. The personalized data set is preferably user specific object data. A personalized data set could be gesture data or models collected from the identified user for better detection of objects. Alternatively, a permissions profile associated with the user may be loaded enabling and disabling particular actions. For example, some users may not be allowed to give gesture input or may only have a limited number of actions. In one variation, at least two users may be detected, and each user may generate a first and second gesture object. Facial recognition may be used in combination with a user priority setting to give gestures of the first user precedence over gestures of the second user. Alternatively or additionally user characteristics such as estimated age, distance from imaging system, intensity of gesture, or any suitable parameter may be used to determine gesture precedence. The user identity may additionally be used to disambiguate gesture control hierarchy. For example, gesture input from a child may be ignored in the presence of adults. Similarly, any suitable type of object may be used to augment a gesture. For example, the left hand or right hand may augment the gestures.

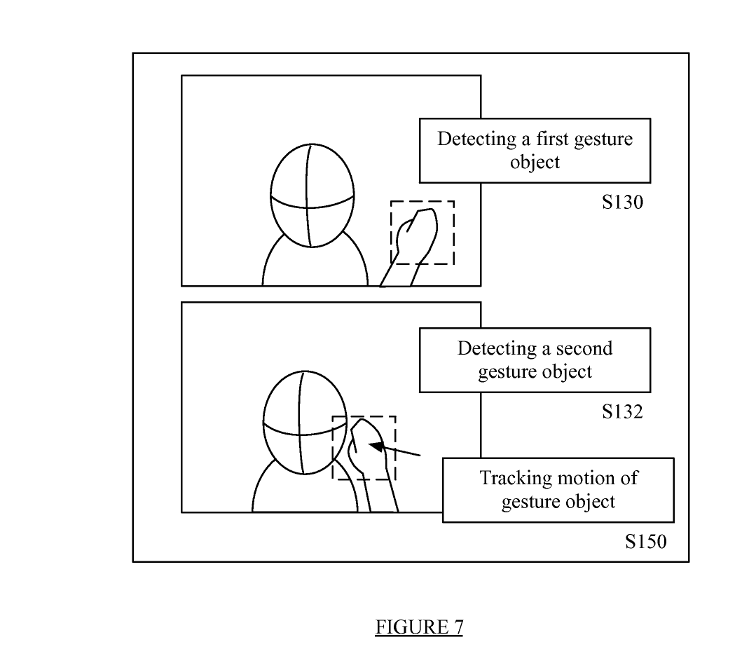

As mentioned about, the method may additionally include tracking motion of an object S150, which functions to track an object through space. For each type of object (e.g., hand or face), the location of the detected object is preferable tracked by identifying the location in the two dimensions (or along any suitable number of dimensions) of the image captured by the imaging unit, as shown in FIG. 7. This location is preferably provided through the object detection process. The object detection algorithms and the tracking algorithms are preferably interconnected/combined such that the tracking algorithm may use object detection and the object detection algorithm may use the tracking algorithm.

The method of a preferred embodiment may additionally include determining operation load of at least two processing units S160 and transitioning operation to at least two processing units S162, as shown in FIG. 8. These steps function to enable the gesture detection to accommodate processing demands of other processes. The operation of the steps that are preferably transitioned include identifying object search area, detecting at least a first gesture object, detecting at least a second gesture, tracking motion of an object, determining an input gesture to the lowest operation status of the at least two processing units, and/or any suitable processing operation. The operation status of a central processing unit (CPU) and a graphics processing unit (GPU) are preferably monitored but any suitable processing unit may be monitored. Operation steps of the method will preferably be transitioned to a processing unit that does not have the highest demand. The transitioning can preferably occur multiple times in response to changes in operation status. For example, when a task is utilizing the GPU for a complicated task, operation steps are preferably transitioned to the CPU. When the operation status changes and the CPU has more load, the operation steps are preferably transitioned to the GPU. The feature vectors and unique steps of the method preferably enable this processing unit independence. Modern architectures of GPU and CPU units preferably provide a mechanism to check operation load. For a GPU, a device driver preferably provides the load information. For a CPU, operating systems preferably provide the load information. In one variation, the processing units are preferably pooled and the associated operation load of each processing unit checked. In another variation, an event-based architecture is preferably created such that an event is triggered when a load on a processing unit changes or passes a threshold. The transition between processing unit is preferably dependent on the current load and the current computing state. Operation is preferably scheduled to occur on the next computing state, but may alternatively occur midway through a compute state. These steps are preferably performed for the processing units of a single device, but may alternatively or additionally be performed for computing over multiple computing units connected by internet or a local network. For example, smartphones may be used as the capture devices, but operation can be transferred to a personal computer or a server. The transition of operation may additionally factor in particular requirements of various operation steps. Some operation steps may be highly parallelizable and be preferred to run on GPUs while other operation steps may be more memory intensive and be prefer a CPU. Thus the decision to transition operation preferably factors in the number of operations each unit can perform per second, amount of memory available to each unit, amount of cache available to each unit, and/or any suitable operation parameters.

### 2. Systems for Detecting Gestures

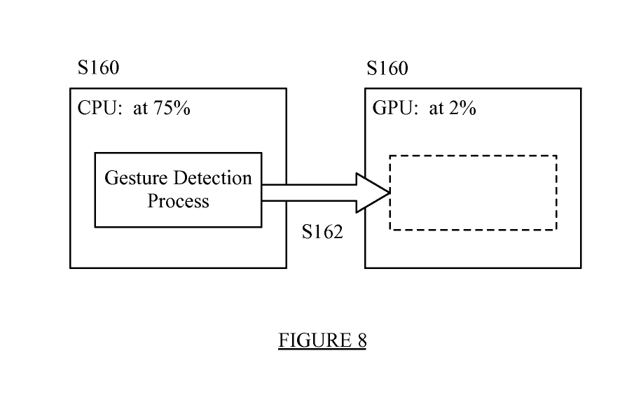

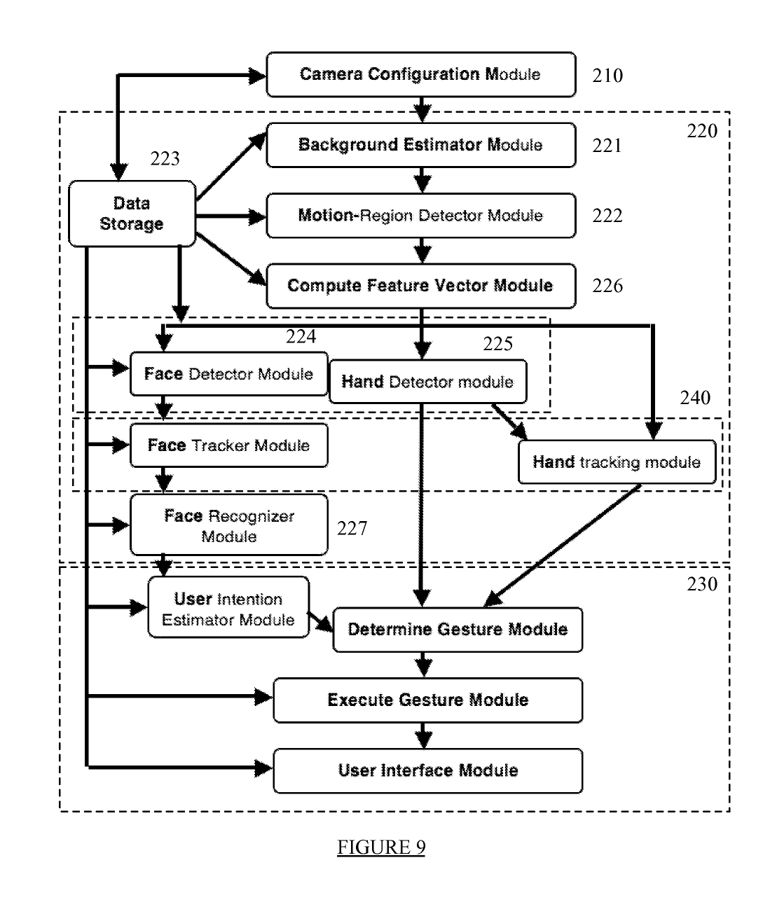

As shown in FIG. 9, system for detecting user interface gestures of a preferred embodiment includes a system including an imaging unit 210, an object detector 220, and a gesture determination module 230. The imaging unit 210 preferably captures the images for gesture detection and preferably performs the steps substantially similar to those described in S110. The object detector 220 preferably functions to output identified objects. The object detector 220 preferably includes several sub-modules that contribute to the detection process such as a background estimator 221, a motion region detector 222, and data storage 223. Additionally, the object detector preferably includes a face detection module 224 and a hand detection module 225. The object detector preferably works in cooperation with a compute feature vector module 226. Additionally, the system may include an object tracking module 240 for tracking hands, a face, or any suitable object. There may additionally be a face recognizer module 227 that determines a user identity. The system preferably implements the steps substantially similar to those described in the method above. The system is preferably implemented through a web camera or a digital camera integrated or connected to a computing device such as a computer, gaming device, mobile computer, or any suitable computing device.

As shown in FIG. 10, the system may additionally include a gesture service application 250 operable in an operating framework. The gesture service application 250 preferably manages gesture detection and responses in a plurality of contexts. For presence-based gestures, gestures may be reused between applications. The gesture service application 250 functions to ensure the right action is performed on an appropriate application. The operating framework is preferably a multi-application operating system with multiple applications and windows simultaneously opened and used. The operating framework may alternatively be within a particular computing environment such as in an application loading multiple contexts (e.g., a web browser) or any suitable computing environment. The gesture service application 250 is preferably coupled to changes in application status (e.g., changes in z-index of applications or changes in context of an application). The gesture service application 250 preferably includes a hierarchy model 260, which functions to manage gesture-to-action responses of a plurality of applications. The hierarchy model 260 may be a queue, list, tree, or other suitable data object(s) that define priority of applications and gesture-to-action responses.

### 3. Method for Detecting a Set of Gestures

As shown in FIG. 11, a method for detecting a set of gestures of a preferred embodiment can include detecting an application change within a multi-application operating system S210; updating an application hierarchy model for gesture-to-action responses with the detected application change S220; detecting a gesture S230; mapping the detected gesture to an action of an application S240; and triggering the action S250. The method preferably functions to apply a partially shared set of gestures to a plurality of applications. More preferably the method functions to create an intuitive direction of presence-based gestures to a set of active applications. The method is preferably used in situations where a gesture framework is used throughout a multi-module or multi-application system, such as within an operating system. Gestures, which may leverage common gesture heuristics between applications, are applied to an appropriate application based on the hierarchy model. The hierarchy model preferably defines an organized assignment of gestures that is preferably based on the order of application use, but may be based on additional factors as well. A response to a gesture is preferably initiated within an application at the highest level and/or with the highest priority in the hierarchy model. The method is preferably implemented by a gesture service application operable within an operating framework such as an operating system or an application with dynamic contexts.

Step S210, which includes detecting an application change within a multi-application operating system, functions to monitor events, usage, and/or context of applications in an operating framework. The operating framework is preferably a multi-application operating system with multiple applications and windows simultaneously opened and used. The operating framework may alternatively be within a particular computing environment such as in an application that is loading multiple contexts (e.g., a web browser loading different sites) or any suitable computing environment. Detecting an application change preferably includes detecting a selection, activation, closing, or change of applications in a set of active applications. Active applications may be described as applications that are currently running within the operating framework. Preferably, the change of applications in the set of active applications is the selection of a new top-level application (e.g., which app is in the foreground or being actively used). Detecting an application change may alternatively or additionally include detecting a loading, opening, closing, or change of context within an active application. The gesture-to-action mappings of an application may be changed based on the operating mode or the active medium in an application. The context can change if a media player is loaded, an advertisement with enabled gestures is loaded, a game is loaded, a media gallery or presentation is loaded, or if any suitable context changes. For example, if a browser opens up a website with a video player, the gesture-to-action responses of the browser may enable gestures mapped to stop/play and/or fast-forward/rewind actions of the video player. When the browser is not viewing a video player, these gestures may be disabled or mapped to any alternative feature.

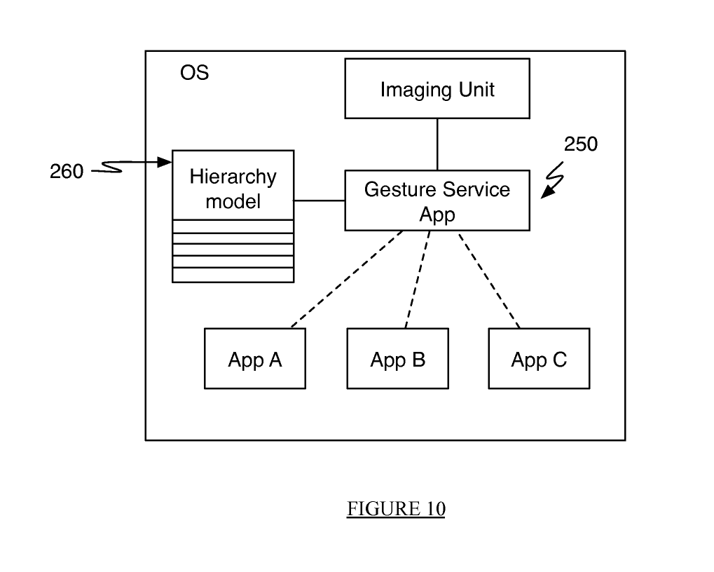

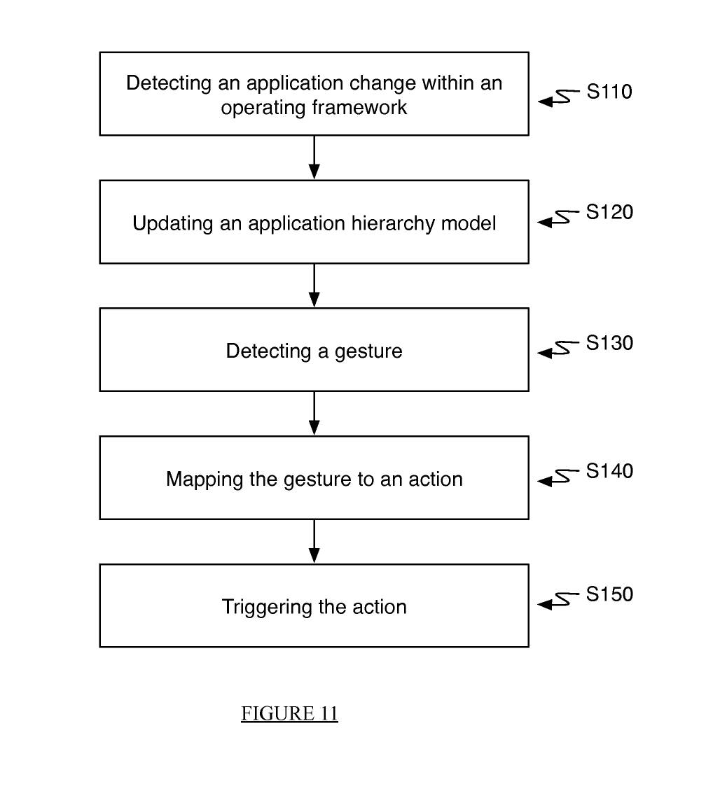

Step S220, which includes updating an application hierarchy model for gesture-to-action responses with the detected application change, functions to adjust the prioritization and/or mappings of gesture-to-action responses for the set of active applications. The hierarchy model is preferably organized such that applications are prioritized in a queue or list. Applications with a higher priority (e.g., higher in the hierarchy) will preferably respond to a detected gesture. Applications lower in priority (e.g., lower in the hierarchy) will preferably respond to a detected gesture if the detected gesture is not actionable by an application with a higher priority. Preferably, applications are prioritized based on the z-index or the order of application usage. Additionally, the available gesture-to-action responses of each application may be used. In one exemplary scenario shown in FIG. 12, a media player may be a top-level application (e.g., the front-most application), and any actionable gestures of that media player may be initiated for that application. In another exemplary scenario, a top-level application is a presentation app (with forward and back actions mapped to thumb right and left) and a lower-level application is a media player (with play/pause, skip song, previous song mapped to palm up, thumb right, thumb left respectively). The thumb right and left gestures will preferably result in performing forward and back actions in the presentation app because that application is higher in the hierarchy. As shown in FIG. 13, the palm up gesture will preferably result in performing a pause/play toggle action in the media player because that gesture is not defined in a gesture-to-action response for an application with a higher priority (e.g., the gesture is not used by the presentation app).

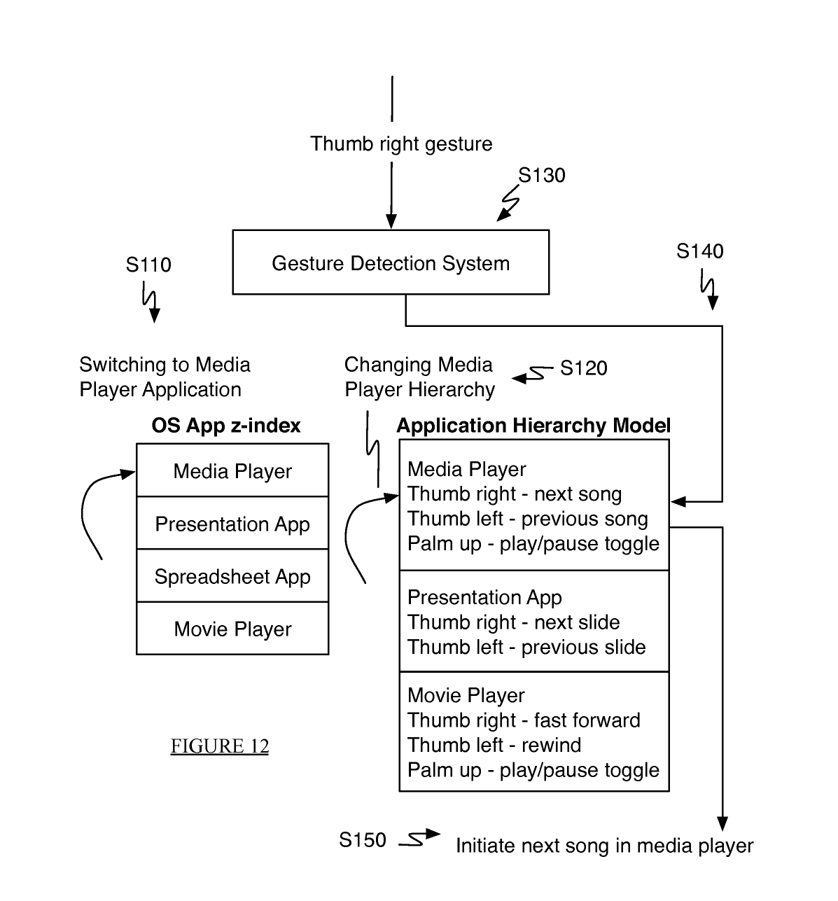

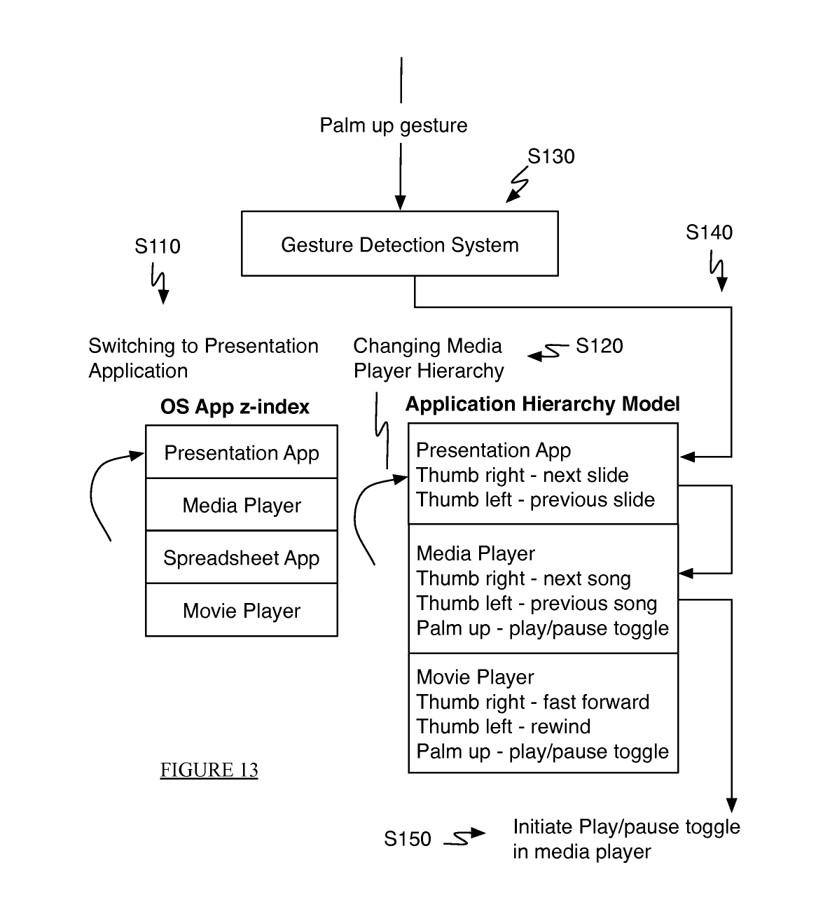

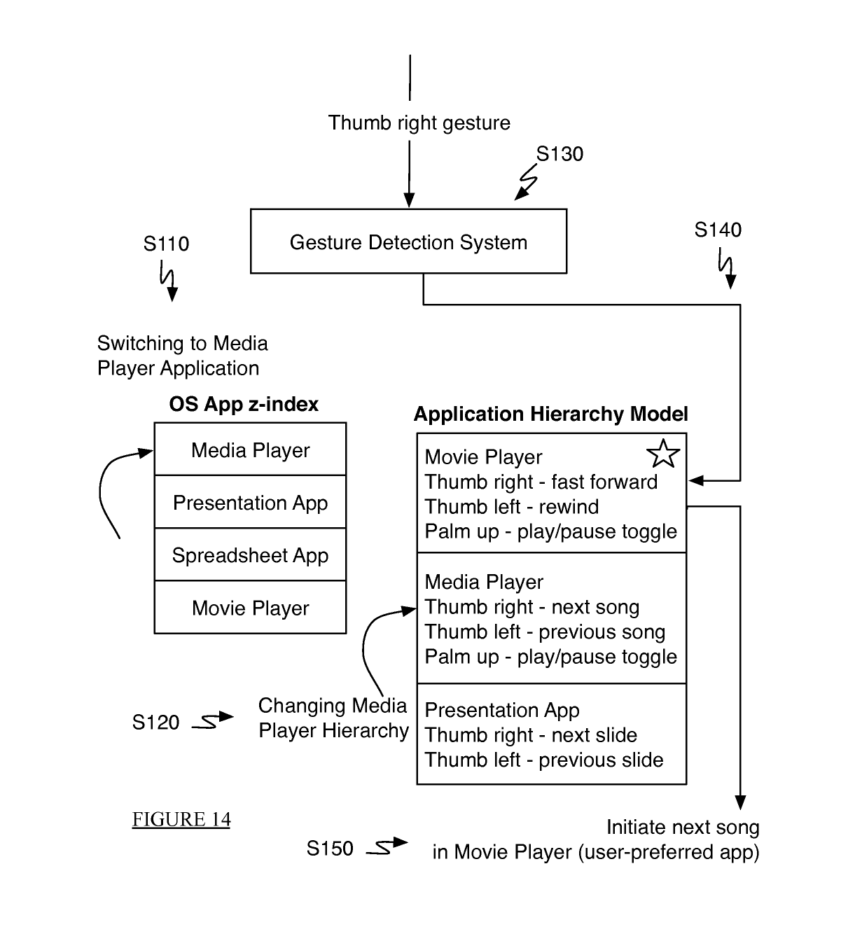

The hierarchy model may alternatively be organized based on gesture-to-mapping priority, grouping of gestures, or any suitable organization. In one variation, a user setting may determine the priority level of at least one application. A user can preferably configure the gesture service application with one or more applications with user-defined preference. When an application with user-defined preference is open, the application is ordered in the hierarchy model at least partially based on the user setting (e.g., has top priority). For example, a user may set a movie player as a favorite application. Media player gestures can be initiated for that preferred application even if another media player is open and actively being used as shown in FIG. 14. User settings may alternatively be automatically set either through automatic detection of application/gesture preference or through other suitable means. In one variation, facial recognition is used to dynamically load user settings. Facial recognition is preferably retrieved through the imaging unit used to detect gestures.

Additionally or alternatively, a change in an application context may result in adding, removing, or updating gesture-to-action responses within an application. When gesture content is opened or closed in an application the gesture-to-action mappings associated with the content is preferably added or removed. For example, when a web browser opens a video player in a top-level tab/window, the gesture-to-action responses associated with a media player is preferably set for the application. The video player in the web browser will preferably respond to play/pause, next song, previous song and other suitable gestures. In one variation, windows, tabs, frames, and other sub-portions of an application may additionally be organized within a hierarchy model. A hierarchy model for a single application may be an independent inner-application hierarchy model or may be managed as part of the application hierarchy model. In such a variation, opening windows, tabs, frames, and other sub-portions will be treated as changes in the applications. In one preferred embodiment, an operating system provided application queue (e.g., indicator of application z-level) may be partially used in configuring an application hierarchy model. The operating system application queue may be supplemented with a model specific to gesture responses of the applications in the operating system. Alternatively, the application hierarchy model may be maintained by the operating framework gestures service application.

Additionally, updating the application hierarchy model may result in signaling a change in the hierarchy model, which functions to inform a user of changes. Preferably, a change is signaled as a user interface notification, but may alternatively be an audio notification, symbolic or visual indicator (e.g., icon change) or any suitable signal. In one variation, the signal may be a programmatic notification delivered to other applications or services. Preferably, the signal indicates a change when there is a change in the highest priority application in the hierarchy model. Additionally or alternatively, the signal may indicate changes in gesture-to-action responses. For example, if a new gesture is enabled a notification may be displayed indicating the gesture, the action, and the application.

Step S230, which includes detecting a gesture, functions to identify or receive a gesture input. The gesture is preferably detected in a manner substantially similar to the method described above, but detecting a gesture may alternatively be performed in any suitable manner. The gesture is preferably detected through a camera imaging system, but may alternatively be detected through a 3D scanner, a range/depth camera, presence detection array, a touch device, or any suitable gesture detection system.

The gestures are preferably made by a portion of a body such as a hand, pair of hands, a face, portion of a face, or combination of one or more hands, a face, user object (e.g., a phone) and/or any other suitable identifiable feature of the user. Alternatively, the detected gesture can be made by a device, instrument, or any suitable object. Similarly, the user is preferably a human but may alternatively be any animal or device capable of creating visual gestures. Preferably, a gesture involves the presence of an object(s) in a set of configurations. A general presence of an object (e.g., a hand), a unique configuration of an object (e.g., a particular hand position viewed from a particular angle) or a plurality of configurations may distinguish a gesture object (e.g., various hand positions viewed generally from the front). Additionally, a plurality of objects may be detected (e.g., hands and face) for any suitable instance. The method preferably detects a set of gestures. Presence-based gestures of a preferred embodiment may include gesture heuristics for mute, sleep, undo/cancel/repeal, confirmation/approve/enter, up, down, next, previous, zooming, scrolling, pinch gesture interactions, pointer gesture interactions, knob gesture interactions, branded gestures, and/or any suitable gesture, of which some exemplary gestures are herein described in more detail. A gesture heuristic is any defined or characterized pattern of gesture. Preferably, the gesture heuristic will share related gesture-to-action responses between applications, but applications may use gesture heuristics for any suitable action. Detecting a gesture may additionally include limiting gesture detection processing to a subset of gestures of the full set of detectable gestures. The subset of gestures is preferably limited to gestures actionable in the application hierarchy model. Limiting gesture detection to only actionable gestures may decrease processing resources, and/or increase performance.

Step S240, which includes mapping the detected gesture to an action of an application, functions to select an appropriate action based on the gesture and application priority. Mapping the detected gesture to an action of an application preferably includes progressively checking gesture-to-action responses of applications in the hierarchy model. The highest priority application in the hierarchy model is preferably checked first. If a gesture-to-action response is not identified for an application, then applications of a lower hierarchy (e.g., lower priority) are checked in order of hierarchy/priority. Gestures may be actionable in a plurality of applications in the hierarchy model. If a gesture is actionable by a plurality of applications, mapping the detected gesture to an action of an application may include selecting the action of the application with the highest priority in the hierarchy model. Alternatively, actions of a plurality of applications may be selected and initiated such that multiple actions may be performed in multiple applications. An actionable gesture is preferably any gesture that has a defined gesture-to-action response defined for an application.

Step S250, which includes triggering the action, functions to initiate, activate, perform, or cause an action in at least one application. The actions may be initiated by messaging the application, using an application programming interface (API) of the application, using a plug-in of the application, using system-level controls, running a script, or performing any suitable action to cause the desired action. As described above, multiple applications may, in some variations, have an action initiated. Additionally, triggering the action may result in signaling the response to a gesture, which functions to provide feedback to a user of the action. Preferably, signaling the response includes displaying a graphical icon reflecting the action and/or the application in which the action was performed.

Additionally or alternatively, a method of a preferred embodiment can include detecting a gesture modification and initiating an augmented action. As described herein, some gestures in the set of gestures may be defined with a gesture modifier. Gesture modifiers preferably include translation along an axis, translation along multiple axis (e.g., 2D or 3D), prolonged duration, speed of gesture, rotation, repetition in a time-window, defined sequence of gestures, location of gesture, and/or any suitable modification of a presence-based gesture. Some gestures preferably have modified action responses if such a gesture modification is detected. For example, if a prolonged volume up gesture is detected, the volume will incrementally/progressively increase until the volume up gesture is not detected or the maximum volume is reached. In another example, if a pointer gesture is detected to be translated vertically, an application may scroll vertically through a list, page, or options. In yet another variation, the scroll speed may initially change slowly but then start accelerating depending upon the time duration for which the user keeps his hand up. In an example of fast forwarding a video, the user may give a next-gesture and system starts fast forwarding the video but then if user moves his hand a bit to the right (indicating to move even further) then the system may accelerate the speed of the video fast-forwarding. In yet another example, if a rotation of a knob gesture is detected, a user input element may increase or decrease a parameter proportionally with the degree of rotation. Any suitable gesture modifications and action modifications may alternatively be used.

### 4. Example Embodiments of a Set of Gestures

One skilled in the art will recognize that there are innumerable potential gestures and/or combinations of gestures that can be used as gesture-to-action responses by the methods and system of the preferred embodiment to control one or more devices. Preferably, the one or more gestures can define specific functions for controlling applications within an operating framework. Alternatively, the one or more gestures can define one or more functions in response to the context (e.g., the type of media with which the user is interfacing. The set of possible gestures is preferably defined, though gestures may be dynamically added or removed from the set. The set of gestures preferably define a gesture framework or collective metaphor to interacting with applications through gestures. The system and method of a preferred embodiment can function to increase the intuitive nature of how gestures are globally applied and shared when there are multiple contexts of gestures. As an example, a “pause” gesture for a video might be substantially identical to a “mute” gesture for audio. Preferably, the one or more gestures can be directed at a single device for each imaging unit. Alternatively, a single imaging unit can function to receive gesture-based control commands for two or more devices, i.e., a single camera can be used to image gestures to control a computer, television, stereo, refrigerator, thermostat, or any other additional and/or suitable electronic device or appliance. In one alternative embodiment of the above method, a hierarchy model may additionally be used for directing gestures to appropriate devices. Devices are preferably organized in the hierarchy model in a manner substantially similar to that of applications. Accordingly, suitable gestures can include one or more gestures for selecting between devices or applications being controlled by the user.

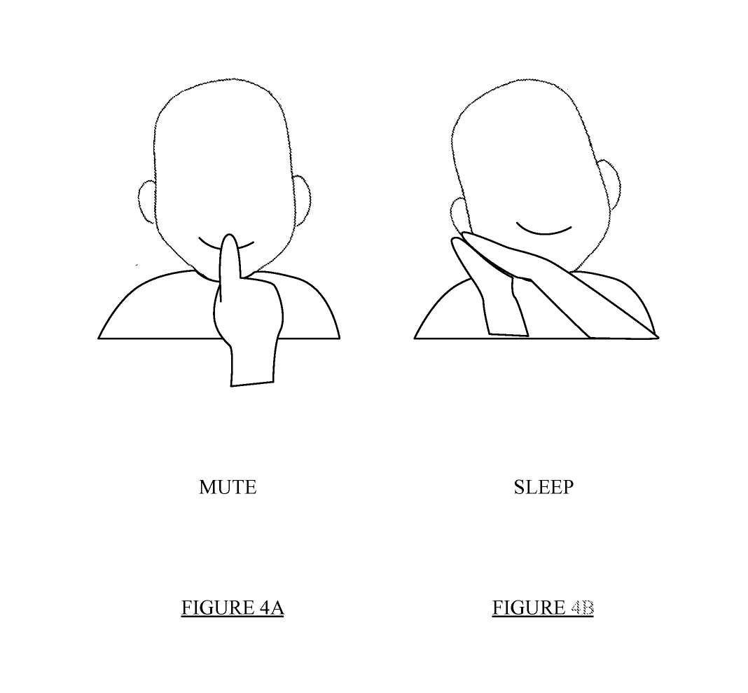

Preferably, the gestures usable in the methods and system of the preferred embodiment are natural and instinctive body movements that are learned, sensed, recognized, received, and/or detected by an imaging unit associated with a controllable device. As shown in FIGS. 4A and 4B, example gestures can include a combination of a user's face and/or head as well as one or more hands. FIG. 4A illustrates an example “mute” gesture that can be used to control a volume or play/pause state of a device. FIG. 4B illustrates a “sleep” gesture that can be used to control a sleep cycle of an electronic device immediately or at a predetermined time. Preferably, the device can respond to a sleep gesture with a clock, virtual button, or other selector to permit the user to select a current or future time at which the device will enter a sleep state. Each example gesture can be undone and/or repealed by any other suitable gesture, including for example a repetition of the gesture in such a manner that a subsequent mute gesture returns the volume to the video media or adjusts the play/pause state of the audio media.

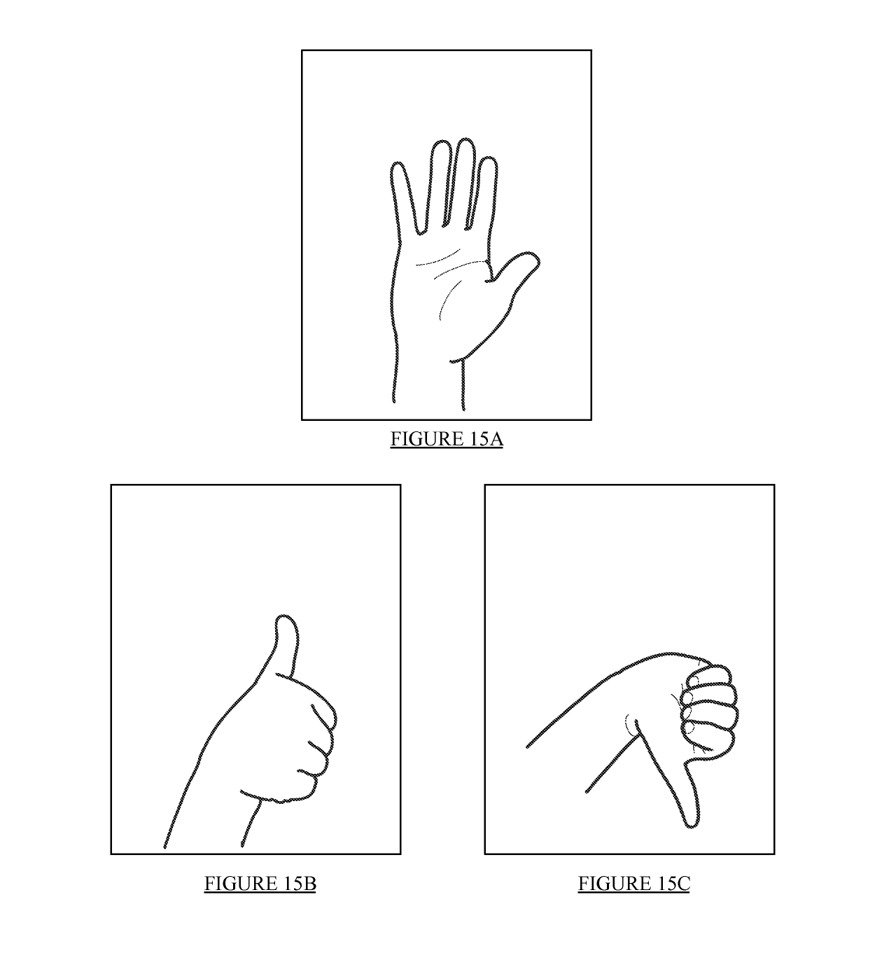

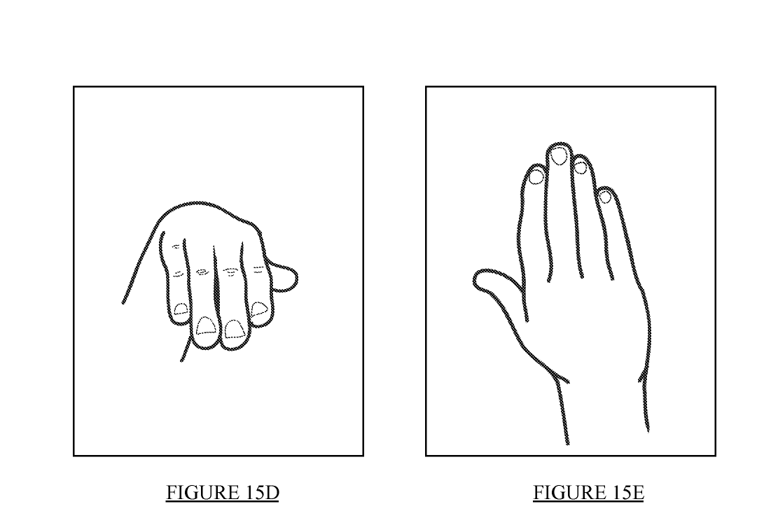

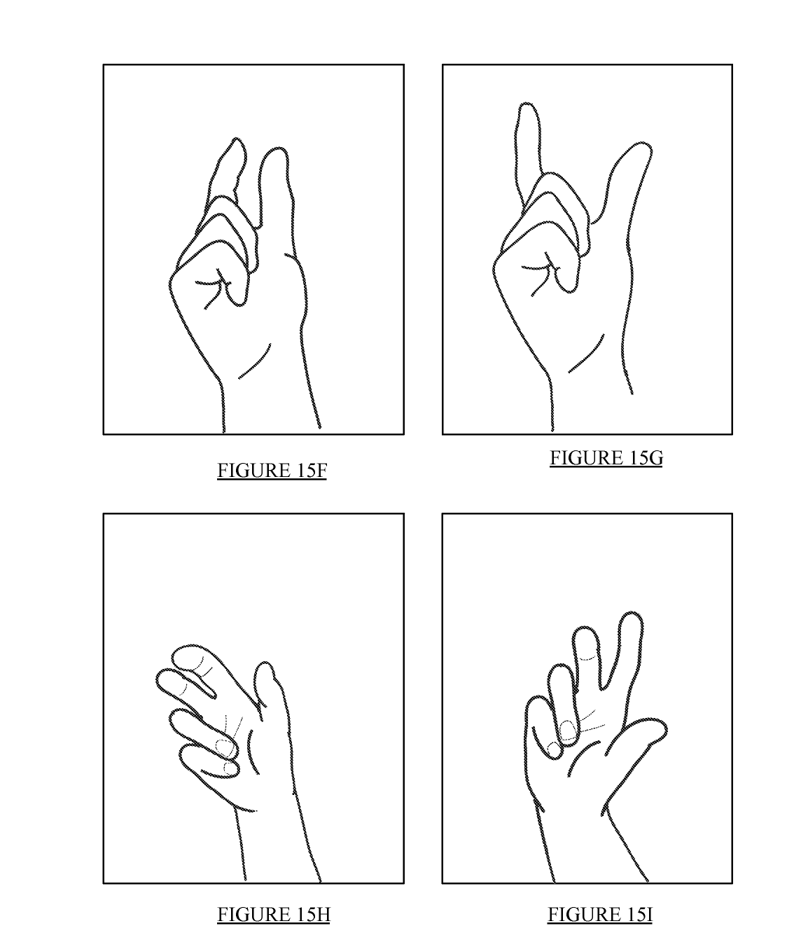

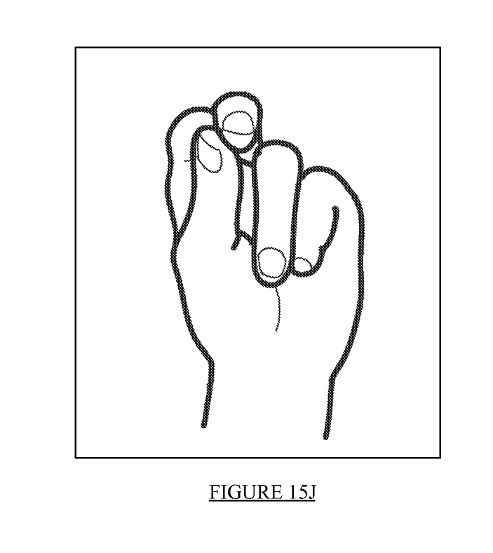

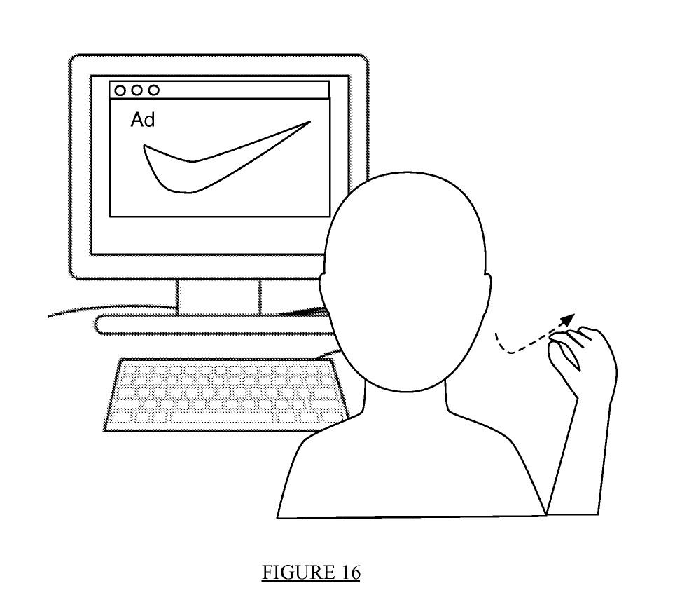

As shown in FIGS. 15A-15I, other example gestures can include one or more hands of the user. FIG. 15A illustrates an example “stop” or “pause” gesture. The example pause gesture can be used to control an on/off, play/pause, still/toggle state of a device. As an example, a user can hold his or her hand in the position shown to pause a running media file, then repeat the gesture when the user is ready to resume watching or listening to the media file. Alternatively, the example pause gesture can be used to cause the device to stop or pause a transitional state between different media files, different devices, different applications, and the like. Repetition and/or a prolonged pause gesture can cause the device to scroll up/down through a tree or menu of items or files. The pause gesture can also be dynamic, moving in a plane parallel or perpendicular to the view of the imaging unit to simulate a pushing/pulling action, which can be indicative of a command to zoom in or zoom out, push a virtual button, alter or change foreground/background portions of a display, or any other suitable command in which a media file or application can be pushed or pulled, i.e., to the front or back of a queue of running files and/or applications.

As noted above, FIG. 15B illustrates an example “positive” gesture, while FIG. 15C illustrates an example “negative” gesture. Positive gestures can be used for any suitable command or action, including for example: confirm, like, buy, rent, sign, agree, positive rating, increase a temperature, number, volume, or channel, maintain, move screen, image, camera, or other device in an upward direction, or any other suitable command or action having a positive definition or connotation. Negative gestures can be used for any suitable command or action, including for example: disconfirm, dislike, deny, disagree, negative rating, decrease a temperature, a number, a volume, or a channel, change, move a screen, image, camera, or device in an upward direction, or any other suitable command or action having a negative definition or connotation.

As shown in FIGS. 15D and 15E, suitable gestures can further include “down” (FIG. 15D) and “up” (FIG. 15E) gestures, i.e., wave or swipe gestures. The down and up gestures can be used for any suitable command or action, such as increasing or decreasing a quantity or metric such as volume, channel, or menu item. Alternatively, the down and up gestures can function as swipe or scroll gestures that allow a user to flip through a series of vertical menus, i.e., a photo album, music catalog, or the like. The down and up gestures can be paired with left and right swipe gestures (not shown) that function to allow a user to flip through a series of horizontal menus of the same type. Accordingly, an up/down pair of gestures can be used to scroll between types of media applications for example, while left/right gestures can be used to scroll between files within a selected type of media application. Alternatively, the up/down/left/right gestures can be used in any suitable combination to perform any natural or intuitive function on the controlled device such as opening/shutting a door, opening/closing a lid, or moving controllable elements relative to one another in a vertical and/or horizontal manner. Similarly, a pinch gesture as shown in FIG. 15J may be used to appropriately perform up/down/left/right actions. Accordingly, a pointer gesture may be used to scroll vertically and horizontally simultaneously or to pan around a map or image. Additionally the pointer gesture may be used to perform up/down or left/right actions according to focused, active, or top-level user interface elements.

As shown in FIGS. 15F and 15G, suitable gestures can further include a “pinch” gesture that can vary between a “closed” state (FIG. 15F) and an “open” state (FIG. 15G). The pinch gesture can be used to increase or decrease a size, scale, shape, intensity, amplitude, or other feature of a controllable aspect of a device, such as for example a size, shape, intensity, or amplitude of a media file such as a displayed image or video file. Preferably, the pinch gesture can be followed dynamically for each user, such that the controllable device responds to a relative position of the user's thumb and forefinger in determining a relative size, scale, shape, intensity, amplitude, or other feature of the controllable aspect. The system and method described above preferably are adapted to recognize and/or process a scale of the user's pinch gesture relative to the motion of the thumb and forefinger relative to one another. That is, to a stationary 2D camera, the gap between the thumb and forefinger will appear to be larger if the user intentionally opens the gap or if the user moves his or her hand closer to the camera while maintaining the relative position between thumb and forefinger. Preferably, the system and method are configured to determine the relative gap between the user's thumb and forefinger while measuring the relative size/distance to the user's hand in order to determine the intent of the apparent increase/decrease in size in the pinch gesture. Alternatively, the pinch gesture can function in a binary mode in which the closed state denotes a relatively smaller size, scale, shape, intensity, amplitude and the open state denotes a relatively larger size, scale, shape, intensity, amplitude of the feature of the controllable aspect.

As shown in FIGS. 15H and 15I, suitable gestures can further include a “knob” or twist gesture that can vary along a rotational continuum as shown by the relative positions of the user's thumb, forefinger, and middle finger in FIGS. 15H and 15I. The knob gesture preferably functions to adjust any scalable or other suitable feature of a controllable device, including for example a volume, temperature, intensity, amplitude, channel, size, shape, aspect, orientation, and the like. Alternatively, the knob gesture can function to scroll or move through a index of items for selection presented to a user such that rotation in a first direction moves a selector up/down or right/left and a rotation in an opposite direction moves the selector down/up or left/right. Preferably, the system and method described above can be configured to track a relative position of the triangle formed by the user's thumb, forefinger, and middle finger and further to track a rotation or transposition of this triangle through a range of motion consummate with turning a knob. Preferably, the knob gesture is measurable though a range of positions and/or increments to permit a user to finely tune or adjust the controllable feature being scaled. Alternatively, the knob gesture can be received in a discrete or stepwise fashion that relate to specific increments within a menu of variations of the controllable feature being scaled.

In other variations of the system and method of the preferred embodiment, the gestures can include application specific hand, face, and/or combination hand/face orientations of the user's body. For example, a video game might include system and/or methods for recognizing and responding to large body movements, throwing motions, jumping motions, boxing motions, simulated weapons, and the like. In another example, the preferred system and method of can include branded gestures that are configurations of the user's body that respond to, mimic, and/or represent specific brands of goods or services, i.e., a Nike-branded “Swoosh” icon made with a user's hand. Branded gestures can preferably be produced in response to media advertisements, such as in confirmation of receipt of a media advertisement to let the branding company know that the user has seen and/or heard the advertisement as shown in FIG. 16. In another variation, the system may detect branded objects, such as a coke bottle and when user is drinking coke bottle. In other variations of the system and method of the preferred embodiment, the gestures can be instructional and/or educational in nature, such as to teach children or adults basic counting on fingers, how to locate one's own nose, mouth, ears, and/or to select from a menu of items when learning about shapes, mathematics, language, vocabulary and the like. In a variation, the system may respond affirmatively every time it asks user to touch nose and user touches their nose. In another alternative of the preferred system and method, the gestures can include a universal “search” or “menu” gesture that allows a user to select between applications and therefore move between various application-specific gestures such as those noted above.

In another variation of the system and method of the preferred embodiment one or more gestures can be associated with the same action. As an example, both the knob gesture and the swipe gestures can be used to scroll between selectable elements within a menu of an application or between applications such that the system and method generate the same controlled output in response to either gesture input. Alternatively, a single gesture can preferably be used to control multiple applications, such that a stop or pause gesture ceases all running applications (video, audio, photostream), even if the user is only directly interfacing with one application at the top of the queue. Alternatively, a gesture can have an application-specific meaning, such that a mute gesture for a video application is interpreted as a pause gesture in an audio application. In another alternative of the preferred system and method, a user can employ more than one gesture substantially simultaneously within a single application to accomplish two or more controls. Alternatively, two or more gestures can be performed substantially simultaneously to control two or more applications substantially simultaneously.

In another variation of the preferred system and method, each gesture can define one or more signatures usable in receiving, processing, and acting upon any one of the many suitable gestures. A gesture signature can be defined at least in part by the user's unique shapes and contours, a time lapse from beginning to end of the gesture, motion of a body part throughout the specified time lapse, and/or a hierarchy or tree of possible gestures. In one example configuration, a gesture signature can be detected based upon a predetermined hierarchy or decision tree through which the system and method are preferably constantly and routinely navigating. For example, in the mute gesture described above, the system and method are attempting to locate a user's index finger being placed next to his or her mouth. In searching for the example mute gesture, the system and method can eliminate all gestures not involving a user's face as those gestures would not quality, thus eliminating a good deal of excess movement (noise) of the user. On the contrary, the preferred system and method can look for a user's face and/or lips in all or across a majority of gestures; and in response to finding a face, determining whether the user's index finger is at or near the user's lips. In such a manner, the preferred system and method can constantly and repeatedly cascade through one or more decision trees in following and/or detecting lynchpin portions of the various gestures in order to increase the fidelity of the gesture detection and decrease the response time in controlling the controllable device. As such, any or all of the gestures described herein can be classified as either a base gesture or a derivative gesture defining different portions of a hierarchy or decision tree through which the preferred system and method navigate. Preferably, the imaging unit is configured for constant or near-constant monitoring of any active users in the field of view.

In another variation of the system and method of the preferred embodiment, the receipt and recognition of gestures can be organized in a hierarchy model or queue within each application as described above. The hierarchy model or queue may additionally be applied to predictive gesture detection. For example, if the application is an audio application, then volume, play/pause, track select and other suitable gestures can be organized in a hierarchy such that the system and method can anticipate or narrow the possible gestures to be expected at any given time. Thus, if a user is moving through a series of tracks, then the system and method can reasonably anticipate that the next received gesture will also be a track selection knob or swipe gesture as opposed to a play/pause gesture. As noted above, in another variation of the preferred system and method, a single gesture can control one or more applications substantially simultaneously. In the event that multiple applications are simultaneously open, the priority queue can decide which applications to group together for joint control by the same gestures and which applications require different types of gestures for unique control. Accordingly, all audio and video applications can share a large number of the same gestures and thus be grouped together for queuing purposes, while a browser, appliance, or thermostat application might require a different set of control gestures and thus not be optimal for simultaneous control through single gestures. Alternatively, the meaning of a gesture can be dependent upon the application (context) in which it is used, such that a pause gesture in an audio application can be the same movement as a hold temperature gesture in a thermostat or refrigerator application.

In another alternative, the camera resolution of the imaging unit can preferably be varied depending upon the application, the gesture, and/or the position of the system and method within the hierarchy. For example, if the imaging unit is detecting a hand-based gesture such as a pinch or knob gesture, then it will need relatively higher resolution to determine finger position. By way of comparison, the swipe, pause, positive, and negative gestures require less resolution as grosser anatomy and movements can be detected to extract the meaning from the movement of the user. Given that certain gestures may not be suitable within certain applications, the imaging unit can be configured to alter its resolution in response to application in use or the types of gestures available within the predetermined decision tree for each of the open applications. The imaging unit may also adjust the resolution by constantly detecting for user presence and then adjusting the resolution so that it can capture user gestures at the user distance from the imaging unit. The system may deploy face detection or upper body of the user to estimate presence of the user and adjust size accordingly.

An alternative embodiment preferably implements the above methods in a computer-readable medium storing computer-readable instructions. The instructions are preferably executed by computer-executable components preferably integrated with a imaging unit and a computing device. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

What is claimed is:

1. A method comprising:
detecting an application change within a multi-application operating system;
updating an application hierarchy model for gesture-to-action responses with the detected application change;
detecting a gesture;
according to the hierarchy model, mapping the detected gesture to an action of an application; and
triggering the mapped action of the application.

2. The method of claim 1, wherein detecting an application change comprises detecting a selection of a new top-level application within the operating system; and updating an application-gesture priority queue comprises promoting the new top-level application in the hierarchy model.

3. The method of claim 2, further comprising signaling a change in the application-gesture priority queue upon updating the application-gesture priority queue.

4. The method of claim 1, wherein detecting application change comprises detecting a change of context within an active application.

5. The method of claim 4, wherein detecting a change of context comprises detecting the loading of a media object in an active application.

6. The method of claim 1, wherein mapping the detected gesture to an action of an application comprises: if a gesture is not actionable within an initial application in the hierarchy model, progressively checking gesture-to-action responses of an application in a lower hierarchy of the hierarchy model.

7. The method of claim 1, wherein detecting a gesture comprises limiting gesture detection processing to a subset of gestures defined by gestures in the application hierarchy model.

8. The method of claim 1, further comprising detecting user settings according to facial recognition of a user; and if an active application is set as a preferred application in the detected user settings, promoting the preferred application in the application hierarchy model.

9. The method of claim 1, wherein a gesture is actionable by at least two applications in the hierarchy model; and wherein mapping the detected gesture to an action of an application comprises selecting the action of the application with the highest priority in the hierarchy model.

10. The method of claim 9, wherein at least one gesture in the set of gestures is defined by a thumbs up gesture heuristic that is used for at least voting, approval, and confirming for a first, second, and third application respectively.

11. The method of claim 1, wherein detecting a gesture comprises detecting a gesture presence from a set of gestures characterized in the gesture-to-action responses in the hierarchy model.

12. The method of claim 11, further comprising for at least one gesture in the set of gestures, subsequently initiating the action for at least a second time if a prolonged presence of the at least one gesture is detected.

13. The method of claim 11, wherein for at least one gesture in the set of gestures, initiating a modified form of the action if a translation of the at least one gesture is detected.

14. The method of claim 13, wherein at least one gesture in the set of gestures is defined by a pinch gesture heuristic; wherein the gesture-to-action response is a scrolling response if the detected gesture is a pinch gesture heuristic and a translation of the pinch gesture along an axis scrolls is detected.

15. The method of claim 11, wherein at least a first gesture in the set of gestures is defined by a thumbs up gesture heuristic, at least a second gesture in the set of gestures is defined by a mute gesture heuristic, and at least a third gesture in the set of gestures is defined by an extended sideways thumb gesture heuristic.

16. The method of claim 15, wherein at least a fourth gesture in the set of gestures is defined by a palm up gesture heuristic and at least a fifth gesture in the set of gestures is defined by a palm down heuristic.

17. A method comprising:
detecting an application change within a multi-application operating framework;
updating an application hierarchy model for gesture-to-action responses with the detected application change;
detecting a gesture from a set of presence-based gestures;
mapping the detected gesture to a gesture-to-action response in the hierarchy model, wherein if a gesture-to-action response is not identified within an initial application in the hierarchy model, progressively checking gesture-to-action responses of an application in a lower hierarchy of the hierarchy model;
if the detected gesture is a first gesture, detecting translation of the first gesture;
if the detected gesture is a second gesture, detecting rotation of the first gesture;
if the detected gesture is a third gesture, detecting prolonged presence of the third gesture; and
triggering the action, wherein the action is modified according to a modified action if defined for translation, prolonged presence or rotation.

18. The method of claim 17, wherein at least one gesture in the set of presence-based gestures is defined by a thumbs up gesture heuristic, at least a one gesture in the set of gestures is defined by a mute gesture heuristic, and at least one gesture in the set of gestures is defined by an extended sideways thumb gesture heuristic.

19. The method of claim 17, wherein at least one gesture in the set of presence-based gestures is defined by a palm up gesture heuristic, and at least a one gesture in the set of gestures is defined by a palm down gesture heuristic.
